(19) United States
(12) Patent Application Publication
(10) Pub. No.: US 2019/0098916 A1
(43) Pub. Date: Apr. 4, 2019

(54) BEE FEED PRODUCTS AND METHODS OF MAKING AND USING SAME

(71) Applicant: PURINA ANIMAL NUTRITION LLC, Shoreview, MN (US)

(72) Inventors: Grace Kunkel, Kirkwood, MO (US); Kent Lanter, Waterloo, IL (US); Bill L. Miller, Labadie, MO (US)

(21) Appl. No.: 15/934,612

(22) Filed: Mar. 23, 2018

Related U.S. Application Data
(60) Provisional application No. 62/568,038, filed on Oct. 4, 2017.

(51) Int. Cl. A23K 10/24; A23K 10/16; A23K 50/90

(52) U.S. Cl. CPC A23K 10/24; A23K 50/90; A23K 10/16

(57) ABSTRACT

Insect feed products include blood meal at a level that enables the product to be used in liquid and patty applications. The product includes particles of dried blood meal and at least one additional feed component. A method of forming a liquid insect feed includes admixing a dry insect feed with a sugar-containing liquid, the insect feed including dried blood meal and at least one additional feed component, the dried blood meal being present in the sugar-containing liquid in an amount such that the admixed insect feed remains in suspension for at least one week. A liquid insect feed product containing particles of spray dried blood and at least one additional feed component suspended in liquid with a viscosity of about 400 to 600 cp and the particles remain suspended in the liquid for at least two weeks.

### CROSS-REFERENCE TO RELATED APPLICATIONS

This application claims priority to U.S. Provisional Application No. 62/568,038, which was filed concurrently with U.S. application Ser. Nos. 15/724,808 and 15/724,750, each of which are herein incorporated by reference in their entirety.

### TECHNICAL FIELD

The present disclosure relates to bee feed products containing blood meal and methods of feeding the products to bees. The products described may remain stable in suspension over an extended period of time.

### BACKGROUND

A challenge to bee survival is overcoming inadequate nutrition. The chief source of protein for most bees is pollen, and insufficient supplies of pollen often lead to diminished bee survival and reduced reproduction rates, causing bee colony size to rapidly diminish. A common solution implemented by beekeepers to counteract this problem is to provide bees with a protein supplement; however, beekeepers are often reluctant to utilize protein supplements due to their tendency to attract small hive beetles. By providing a substrate for the SHBs to lay eggs and develop, the supplements may foster beetle infestation and colonization. Bees typically consume much less, if any, of an infested feed composition, resulting in wasted feed, increased pest loads, decreased bee nutrition, potentially leading to bee death, and large monetary losses.

Beekeepers may thus be confronted with a catch-22: provide a protein supplement to address pollen shortages but risk small hive beetle infestation, or minimize the risk of small hive beetle infestation by refraining from providing a protein supplement at the cost of the colony's nutrition. Improved bee feed compositions are therefore needed to solve this dilemma by addressing shortages in natural protein without increasing the likelihood of small hive beetle infestation.

### SUMMARY

Implementations provide improved insect feed products and methods of making and using the products, such as bee feed products, comprised of blood meal. The blood meal in the bee feed products is provided at a level which enables the product to be used in liquid and patty applications.

According to certain implementations, an insect feed product includes particles of dried blood meal and at least one additional feed component.

According to other implementations, a method of forming a liquid insect feed includes admixing a dry insect feed with a sugar-containing liquid, the insect feed including dried blood meal and at least one additional feed component, the dried blood meal being present in the sugar-containing liquid in an amount such that the admixed insect feed remains in suspension for at least one week.

In yet other implementations, a liquid insect feed product includes particles of spray dried blood and at least one additional feed component suspended in liquid, where a viscosity of the liquid is about 400 to 600 cp and where the particles remain suspended in the liquid for at least two weeks.

In various implementations and alternatives, the dried blood meal may be a primary protein source in the product, and protein may account for about 18 to about 70 wt % of the product. The dried blood meal may be spray dried. Spray dried blood meal may account for about 40 to 60 wt % of the product. The at least one additional feed component may include yeast. The yeast may account for about 40 to 60 wt % of the product. In approaches, about 90% of the particles may have a particle size of under about 45 μm, and about 98% of the particles may have a particle size under about 55 μm. In addition or alternatively, about 90% of the particles may have a particle size under 45 μm, and about 10% of the particles may have a particle size greater than 45 μm. The sugar-containing liquid, or liquid, may include corn syrup, sugar syrup, or liquid sucrose, liquid fructose.

### DETAILED DESCRIPTION

Implementations provide bee feed products comprised of blood meal, and methods of making and feeding such feed products to bees. Despite having a form, texture, and overall nutritional content substantially similar to other bee feed products that do not contain blood meal, the feed products described herein may remain stable in suspension over an extended period of time, such as 24 hours, one week or two weeks or longer, e.g., three, four, five or six weeks. Blood meal may be present in the product in an amount such that the product remains suspended for this extended period. Other components may facilitate suspension of the product, however, the blood meal, which can be finely ground into small, uniformly sized particles, may contribute to the product's ability to remain suspended over time. The feed products of the present disclosure may contain high levels of protein in the form of blood meal to compensate for low pollen availability in the surrounding environment, and may thus be considered protein supplements or even pollen substitutes. Unlike preexisting protein supplements, however, the blood meal may comprise the primary protein source in the compositions described herein. Accordingly, traditional protein sources may be absent or nearly absent from these newly developed bee feed products, while simultaneously providing bee feed product that remains stable in suspension in liquid feed applications. Moreover, the bee feed product may additionally or alternatively be used in solid feed applications.

Bee Feed Products

The bee feed products disclosed herein may include a bee feed composition containing blood meal and at least one additional feed component. In various embodiments, the feed composition may comprise a dry, powder-like composition (e.g., with a moisture content of about 3 to 15 wt %), which may be combined with one or more liquids, e.g., syrup such as corn syrup. The feed composition may also contain high levels of protein, and may thus be considered a protein supplement that may be admixed with one or more additional feed materials and/or liquids to form a final feed product with adequate protein levels.

The particle size of the bee feed compositions may resemble the particle size of natural pollen grains but may be less dense than pollen due to the low moisture content of the bee feed products. The small, finely ground particles may be instrumental in causing the bee feed compositions herein to remain more uniformly distributed in liquid solution over time compared to preexisting products comprising larger and/or variably sized particles. As a result, bees fed the disclosed feed products can be provided with access to a more consistent source of nutrition compared to bees fed other products. In embodiments, at least a portion of the bee feed composition may have a particle size up to about 100 μm, up to about 90 μm, up to about 80 μm, up to about 70 μm, up to about 60 μm, up to about 55 μm, up to about 50 μm, up to about 45 μm; may range from about 10 μm to about 1000 μm, from about 15 μm to about 80 μm, from about 20 μm to about 70 μm, or from about 40 μm to about 60 μm. In embodiments, about 90% of the particles may be under 45 μm, and about 98% of the particles may be under 53 μm and may provide a uniform particle size. In other embodiments, about 90% of the particles may be under 45 μm and about 10% of the particles may have a size greater than 45 μm.

Implementations of the bee feed products with a uniform particle size, such as about 90% of the particles having a particle size of under about 45 μm, and/or 98% of the particles having a particle size under about 55 μm, may facilitate maintaining the bee feed product in a stable suspension. For instance, providing the bee feed product containing blood meal and with this particle size distribution may contribute to providing this stable suspension. In implementations, the bee feed product remains stable in suspension of a liquid bee feed containing about 1 to about 10 wt % of the bee feed product where the liquid bee feed has a viscosity of about 400 cp to about 600 cp, about 400 cp to about 550 cp, about 450 cp to about 550 cp, about 450 cp to about 500 cp, about 500 cp to about 550 cp, about 475 cp to about 525 cp, or about 510 cp.

In some embodiments, blood meal may comprise the primary component, by weight, of the entire feed composition, such that no other feed component comprises a greater weight percentage of the composition than blood meal. Alternatively, blood meal may comprise the second greatest component, by weight, of the entire feed composition. In some examples, blood meal may comprise at least about 50 wt % of the feed composition. In various embodiments, the blood meal content may range from about 48 wt % to about 52 wt %. In some examples, this amount may vary, ranging from about 35 wt % to about 65 wt %, about 30 wt % to about 50 wt %, about 40 wt % to about 50 wt %, about 40 wt % to about 60 wt %, about 45 wt % to about 55 wt %, or about 49 wt %. Embodiments in which the feed composition is mixed with a liquid, e.g., syrup, and in some cases formed into suspensions or patties, may include an overall blood meal content ranging from about 10 wt % to about 30 wt %, about 15 wt % to about 25 wt %, about 20 wt % to about 30 wt %, about 25 wt % to about 30 wt %, about 18 wt % to about 24 wt %, or about 20 wt % to about 22 wt %. Feed compositions mixed with a liquid or heavy syrup to form a solution or suspension may remain substantially uniformly dispersed over time. For example, a uniformly mixed solution comprised of about 5 wt % feed composition and about 95 wt % liquid, e.g., corn syrup, may maintain an approximately uniform distribution of the feed composition in a container over at least a 24 hour period, such that the proportion of the feed composition present in the top ⅓, middle ⅓, and bottom ⅓ of the contained solution remains about the same over the 24 hours. In some embodiments, the proportion of a feed composition present in the top ⅓, middle ⅓, and bottom ⅓ of the contained solution may only change by about 8.96% after 24 hours. According to such embodiments, none of the specific sub-portions of the solution may show any appreciable increase or decrease in the proportion of the product residing therein after 24 hours, and for extended periods thereafter, such as 7 days or more. By contrast, preexisting feed composition products, when mixed in a solution, may typically exhibit substantial redistribution and/or localization of the feed composition after 24 hours, evidenced by the accumulation of the compositions either at the top or bottom of a contained solution. In some examples, redistribution of the feed compositions disclosed herein after about 24 hours in solution, i.e., away from an initial equal distribution, may be about 2.3 to about 5 times less substantial than redistribution of preexisting products, e.g., AP 23 (Dadant) and Megabee, after 24 hours in solution. Accordingly, the disclosed feed products may remain substantially more uniformly dispersed after 24 hours or more in solution than preexisting products, indicating that the disclosed products, when provided in a liquid solution or suspension, can provide a more consistent supply of protein over time.

According to certain implementations, the at least one additional feed component in the bee feed product may include yeast. In embodiments, where blood meal comprises the second greatest component, by weight, of the entire feed composition, yeast may comprise the primary component of the entire feed composition, such that no other feed component comprises a greater weight percentage of the composition than yeast. Various types of yeast, e.g., brewer's yeast, baker's yeast, grain distillers dried yeast, and/or torula yeast, may be used. In some examples, brewer's yeast may serve as an additional source of protein and as a bee attractant. The amount of yeast may vary in different implementations, ranging from about 10 wt % to about 60 wt %, about 20 wt % to about 60 wt %, about 30 wt % to about 60 wt %, about 40 wt % to about 60 wt %, about 40 wt % to about 50 wt %, or about 43 wt % to about 47 wt % of the feed composition.

The total protein content of the feed composition may range from about 18 wt % to about 70 wt %, about 30 wt % to about 60 wt %, about 50 wt % to about 60 wt %, about 55 wt % to about 60 wt %, about 55 wt % to about 57 wt %, about 35 wt % to about 45 wt %, or at least about 50 wt %, or about 55 wt % of the total feed composition.

Blood meal comprises at least a portion of the protein content of the feed compositions. In various embodiments, blood meal may comprise the majority, by weight, of the protein in the feed composition, such that the blood meal comprises greater than 50 wt % of the total protein content. In other examples, blood meal may comprise the entire protein content of the feed composition. In some examples, the blood meal content of the total protein may range from about 50 wt % to about 100 wt %, about 60 wt % to about 100 wt %, about 70 wt % to about 100 wt %, about 80 wt % to about 100 wt %, or about 90 wt % to about 100 wt % of the total protein.

In various embodiments, the bee feed compositions may be free or substantially free of traditional protein sources, which may comprise the primary protein components of preexisting feed compositions and protein supplements. Traditional protein sources excluded from the feed compositions in some examples may include yeast, corn gluten meal, soy or soy products, and/or egg powder. In other examples, the bee feed products may contain one or more of yeast, corn gluten meal, soy, and egg powder. In such embodiments, blood meal may still comprise the primary protein source by weight percent of the overall feed composition. For instance, embodiments may include corn gluten meal, soy, and/or egg powder in amounts ranging from about 1 wt % to about 20 wt %, about 5 wt % to about 15 wt %, about 8 wt % to about 12 wt %, or about 5 wt % to about 10 wt % of the total bee feed composition.

In addition or alternatively, the bee feed product may include fats in an amount sufficient to fulfill the fat nutritional requirements of bees. Fat sources in the feed composition may include, but are not limited to: various edible oils, e.g., vegetable oils, encapsulated essential oils, medium chain fatty acids, sterols, and/or propionic acid. The fat content may vary in embodiments, ranging from about 1 wt % to about 15 wt %, about 1 wt % to about 5 wt %, about 2 wt % to about 4 wt %, about 3 wt % to about 12 wt %, about 4 wt % to about 10 wt %, or about 5 wt % to about 8 wt % of the feed composition.

Feed compositions may include various amounts of fiber derived from various sources. The fiber content may range from about 1 wt % to about 10 wt %, about 1 wt % to about 7 wt %, about 2 wt % to about 4 wt %, or about 3 wt % to about 6 wt %.

Various minerals, amino acids and micronutrients may also be included in the feed composition. Such components may include, but are not limited to: iron, choline chloride, copper, copper sulfate, zinc, zinc sulfate, potassium, potassium chloride, potassium sorbate, chromium, aluminum, phosphorus, manganese, manganese sulfate, magnesium, magnesium sulfate, calcium, calcium sulfate, calcium iodate, calcium pantothenate, calcium propionate, sodium, sodium molybdate, isoleucine salt, cadmium, selenium, sulfur, nickel, L-tryptophan, and/or lead. The amount of vitamins, minerals, and/or micronutrients may range from about 0.1 wt % to about 10 wt %, about 0.5 wt % to about 8 wt %, about 1 wt % to about 7 wt %, or about 2 wt % to about 5 wt % of the feed composition. Particular embodiments may include calcium at about 0.2 wt % to about 1.0 wt %, about 0.3 wt % to about 0.9 wt %, or about 0.4 wt % to about 0.9 wt %. Particular embodiments may include phosphorus at about 0.3 wt % to about 1.5 wt %, about 0.4 wt % to about 1.0 wt %, or about 0.5 wt %. Sodium content may also vary, ranging from about 0.3 wt % to about 1.5 wt %, about 0.4 wt % to about 1.0 wt %, or about 0.5 wt % in various examples. Sulfur content may also vary, ranging from about 0.3 wt % to about 1.5 wt %, about 0.4 wt % to about 1.0 wt %, about 0.5 wt % to about 0.9 wt %, about 0.6 wt % to about 0.8 wt %, or about 0.7 wt %. The selenium content may range from about 0.75 mg/kg to about 1.25 mg/kg, about 0.8 mg/kg to about 1.15 mg/kg, or about 0.9 mg/kg to about 1.08 mg/kg of the feed composition.

Various vitamins and vitamin sources may also be included in the feed composition. Vitamins may include vitamin A, vitamin K, riboflavin, pyridoxine, pyridoxine hydrochloride, thiamine, thiamine mononitrate, citric acid, nicotinic acid, vitamin A acetate, vitamin E supplement, vitamin B12 supplement, cholecalciferol, menadione sodium bisulfite complex, pantothenic acid, inositol, folic acid, biotin, L-ascorbyl-2-polyphosphate, P-aminobenzoic acid, and/or gibberellin acid.

The moisture content of the feed composition may also vary. In some examples, the feed composition may be dry, e.g., granulated or powder-like. The moisture content may range from about 3 wt % to about 15 wt %, about 4 wt % to about 10 wt %, about 5 wt % to about 8 wt %, or about 6 wt % to about 8 wt % in various examples.

By providing a variety of nutrients, the foregoing feed components may provide bees with the nutritional diversity usually obtained only through natural foraging behavior. Embodiments are not limited to the nutritional components listed herein, however, and may contain a large variety of other nutrient combinations in various amounts. Feed components not critical to the proper formation of protein-rich feed products, in particular, can be substituted or omitted. For instance, products described herein may be free or substantially free (e.g., less than 1 percent by weight) of any of the foregoing components. In addition, the products may be free of insecticides, pesticides, or combinations thereof. More specifically, the blood meal contained in the products of the present disclosure may serve as a natural approach to deterring SHB infestation, meaning the products may be free or substantially free of certain chemicals, e.g., insecticides that may otherwise be used to deter insects. In some examples, the products may be free of permethrin and/or coumophos.

Bee feed products provided herein may be mixed with other nutrients to form a final feed product in some examples. Different nutrients such as protein, fats, and/or carbohydrates may be used. For example, one or more of the previously described protein, fat and/or carbohydrate sources may be admixed with the bee feed products. In a more particular example, sugar-based carbohydrates may be included. Liquid sugar-based carbohydrates may be high in sucrose and may include, for example, honey, syrup, corn syrup, sugar syrup, liquid sucrose, fructose, and/or molasses. Additional or alternative carbohydrate sources may include various types of flour, e.g., canola flour, sunflower flour, sorghum flour, wheat flour, and/or triticale flour.

In embodiments where the bee feed products are combined with liquid bee feed as an admixture, such as the liquid sugar-based carbohydrates, the liquid bee feed may have a viscosity of about 400 cp to about 600 cp, about 400 cp to about 500 cp, about 450 cp to about 500 cp, or about 480 cp. In such embodiments, the bee feed product may account for about 1 to about 10 wt %, about 1 to about 8 wt %, about 2 to about 8 wt %, about 3 to about 8 wt %, about 3 to about 7 wt %, about 4 to about 7 wt %, about 5 to about 10 wt %, or about 1 wt %, about 2 wt %, about 3 wt %, about 4 wt %, about 5 wt %, about 6 wt %, about 7 wt %, about 8 wt %, about 9 wt %, or about 10 wt % of the admixture. The protein delivered through the bee feed product may account for about 0.5 to about 5.0 wt %, about 1.0 to about 5.0 wt %, about 1.0 to about 4.0 wt %, about 1.0 to about 3.0 wt %, about 2.0 to about 5.0 wt %, about 2.0 to about 4.0 wt %, about 3.0 to about 5.0 wt %, or about 0.5, 1.0, 2.0, 3.0, 4.0 or 5.0 wt % of the admixture.

For some liquid bee feed applications, at least about 1 pound of bee feed product may be mixed with about 1.7 gallons of the liquid bee feed. The admixture may be mixed at low speeds for a time, such as about 30 minutes.

While suspension agents may be included in the bee feed products, the presence of blood meal in the product contributes to the ability of the bee feed product to remain in suspension in the liquid bee feeds. In some implementations, suspension agents such as xanthan gum may be included. Other suspension agents may include but are not limited to: alginates, gelatin, cellulose (e.g., microcrystalline or powdered), acacia, tragacanth, bentonite, carbomer, carageenan. The suspension agents may be present in the bee feed products at about 0.05 to about 5.0 wt %, about 0.05 to about 3.0 wt %, about 0.05 to about 2.0 wt %, about 0.05 to about 1.0 wt %, or about 0.05 to about 0.5 wt %.

The bee feed products may include anti-foaming agents such as silicone agents, e.g., Magrabar Silicone 10-sn, polydimethylsiloxane, silicon dioxide (e.g., fumed silica), clays (e.g., attapulgite clay).

The feed products may be formulated specifically for bees having little or no access to pollen. For example, the feed products described herein may be particularly well-suited for honey bees having no access to forage.

Methods of Making Bee Feed Products

To achieve the desired particle size, embodiments may involve spray drying, grinding and/or passing portions of the feed compositions through a sieve to ensure that a specific particle size is attained, or at least to exclude excessively large particles from the feed composition. After grinding and/or sieving, the feed compositions may be substantially homogenous.

The blood used to form the blood meal may be captured as a byproduct of processing various animals, e.g., livestock or poultry. The blood may then be dried to form a powder, e.g., spray dried blood. In some implementations, the blood meal may be spray dried. The blood meal may have a moisture content of about 3 wt %. The blood meal may include one or more of the 10 amino acids essential to the honey bee diet, including but not limited to: methionine, tryptophan, arginine, lysine, histidine, phenylalanine, isoleucine, threonine, leucine and valine.

In implementations, the bee feed product may be an admixture of spray dried blood meal and yeast that has been ground to a desired particle size. In embodiments, the bee feed composition may have a particle size up to about 100 μm, may range from about 10 μm to about 1000 μm, or may have other particles sizes and/or size ranges disclosed herein In embodiments, about 90% of the particles may be under 45 μm, and/or about 98% of the particles may be under 53 μm.

Methods of Feeding Bees

Bees fed according to the methods herein may include honey bees from the Apidae family. Embodiments may involve feeding various species of bees, from the Apidae family or other families. In specific examples, the bees may comprise the western honey bee (Apis mellifera). Bees may be fed on ad libitum basis in some embodiments. The total amount of feed provided for bees at any one time may vary depending on the number of bees being fed, the time of year, and/or the availability of other sources of artificial or natural pollen. In embodiments, bees may be fed the bee feed product between pollinations when the availability of pollen is low. In some embodiments, the feed products disclosed herein may comprise all or a portion of the bees' daily feed ration.

Generally, bees are fed in a group setting such as a colony. In some embodiments, the bees may be confined to cages, boxes or crates. In alternative embodiments, the bees may be unconfined and free to roam. Accordingly, the feeding methods disclosed herein may utilize a variety of feeding apparatuses placed in various locations. In some embodiments, the bee feed products may be provided in bee feeders, which are containers accessible to bees, as patties, may be applied directly on natural objects, e.g., plants, to provide the bees with feed products in their natural environment. In other embodiments, the bee feed products may be provided in one or more strategically-selected locations to stimulate movement of the bees as desired. In still other embodiments, the bee feed products may be placed in one or more locations where pollen sources are scarce. In addition, or alternatively, methods of feeding may incorporate apparatuses that visually emulate pollen-producing plants.

Using the feed compositions disclosed herein, the final feed product provided to the bees may be prepared and provided in various ways. For instance, the feed compositions, which may be in the form of a dry supplement, may be mixed with various amounts of liquid carbohydrates, e.g., heavy sugar syrup, corn syrup and/or liquid sucrose, to attain liquid feed products or to attain a patty product. Unlike prior approaches in which bee supplements settle to the bottom of a liquid bee feed, resulting in the bee supplement being suitable only for patty applications, the bee feed products containing blood meal remain suspended in liquid bee feed over an extended period of time, as well as being useful in patty applications. The bee feeders may be vessels with an open top or openings at or near the bottom of the vessel such that one or more openings are accessible to bees. For instance, the bee may access the top or the bottom of the container and consume the bee feed product-containing syrup. Because the bees eat from the top or the bottom of the vessel depending on the design, the distribution of the bee feed product should be similar throughout the container. For instance, implementations provide protein from the bee feed product at about 20% to about 60% in each of the top, middle and bottom portions of the admixture. In some implementations, about 20% to about 40% of the protein from the supplement is found in portion of the admixture. In other implementations, about 20% to about 70% of the protein from the supplement is found in portion of the admixture. These described implementations are in contrast to some prior approaches in which over 80% of the protein from bee feed supplements is present at the top of the mixture, resulting in problems with uneven delivery of protein to bees. In other prior approaches, nearly all of the bee feed supplement tended to settle at the bottom of a feeder, making the supplement unavailable when the bees have access to the top of the feeder, or causing clogging problems with the bee feeder openings positioned near the bottom of the feeder.

To form a liquid feed product comprised of about 5 wt % feed composition and about 95 wt % added carbohydrate, for example, about 1 lb. of the feed composition may be mixed with about 1.7 gallons of liquid bee feed. To scale up the amount of liquid feed product produced, the amount of feed composition and liquid bee feed (e.g., liquid sugar-based carbohydrates) may be increased accordingly. For example, about 5 lbs. of the feed composition may be combined with about 8.5 gallons of syrup, about 10 lbs. of feed composition may be combined with about 17 gallons of liquid bee feed, about 20 lbs. of feed composition may be combined with about 34 gallons of liquid bee feed, or about 40 lbs. of feed composition may be combined with about 68 gallons of liquid bee feed. Liquid feed products may have a viscosity of about 400 cp to about 600 cp, about 400 cp to about 500 cp, about 450 cp to about 500 cp, or about 480 cp. After combining the feed composition with the syrup, the two components may be mixed slowly (e.g., at about 60 to about 95 RPM) over a time period, such as about 30 minutes. Mixing may occur at ambient temperatures, e.g., 65 to 85 ° F. To avoid separating the feed composition from the carbohydrate, e.g., syrup, the mixing apparatus should be kept at a low setting. This can avoid whipping air into the mixture, which may lead to separation.

In embodiments where a patty is provided to bees, the patty may be formed by mixing about 1 part of the bee feed product with about 1.3 parts of liquid bee feed (e.g., syrup). For instance, 1 pound of the bee feed product may be mixed with 1.3 pounds of the liquid bee feed until a patty of a desired consistency is formed. In some approaches the patty may be formed ahead of use, for instance at least about 24 hours ahead of use. In some approaches, liquid bee feed may be periodically added to the patty, such as daily, every two days, every three days, every four days. The addition of liquid bee feed to the patty may improve the consistency of the patty due to the absorption of moisture in the patty during use.

In use, one bee colony may be provided with a single, one-pound (-454 grams) feed patty on a weekly basis. At the end of each week, a fresh one-pound patty may be provided, regardless of whether the previously-provided patty is completely consumed. In some examples, the feed products may be replenished (e.g., liquid bee feed added) before the previously-provided products are consumed, such that the bees have constant access to the feed products. Accordingly, the frequency with which patties are replaced and the size of each patty may vary. In various embodiments, the amount of bee feed products consumed by the bees on a weekly basis may range from about 100 grams to about 750 grams, about 150 grams to about 700 grams, about 200 grams to about 650 grams, about 250 grams to about 600 grams, about 300 grams to about 550 grams, about 350 grams to about 500 grams, or about 400 grams to about 450 grams of the feed product per week. Until provided to bees, the bee feed products may be stored at reduced temperatures, e.g., at or below freezing, to preserve products not immediately consumed.

The methods disclosed herein may be used to feed adult bees, beginning immediately after emergence from the larval cell. In some embodiments, bees may be fed according to these methods beginning at about 0, 1, 2, 3, 4 or 5 or more days after emergence. Bees may continue to be fed according to these methods for the duration of their life span or for shorter, finite periods. Bees may be fed over the entirety of any of the aforementioned periods or for intermittent spans of time falling within or overlapping with these periods. Bees may be fed on a daily, weekly or monthly basis, and when provided in a liquid solution, the bee feed products described herein may remain more uniformly distributed over time relative to preexisting products. In some examples, the bee feed products disclosed herein may be offered to bees on a less frequent basis relative to preexisting products when prepared in a solution due to the more uniform distribution of the disclosed products observed over time. In some examples, bees may be fed irregularly and/or upon total consumption of the feed products.

### EXAMPLES

Trial 1. This example observes suspension properties of various honey bee protein supplements.

### Materials and Methods:

Materials: The feeds tested include commercially available: AP 23 (Dadant) and Megabee powder. The bee feed product of the present disclosure will be sold as Hearty Bee (Purina Animal Nutrition, a Land O'Lakes Company). Each of the products was mixed in a same sized and shaped container and mixed using a mixer (Kitchen aide between 60 and 95 RPM's)

Disposable pipettes were used for sampling to determine protein levels in the admixtures. A camera recorded the mixing.

Methods: AP 23 and Megabee were mixed with the same amount of syrup as only Megabee included mixing directions on the label. Both products were mixed using 1 lb. of powder and 2 gallons of heavy syrup. The bee feed product (Hearty Bee) was mixed using 5 wt % dry powder and 95 wt % heavy syrup. The admixtures were mixed slowly for 30 minutes to avoid separation and avoid whipping air into the mixtures.

The feeds were all mixed on the same day and then placed into a series of identical containers and visually observed daily for seven days. Samples were photographed periodically to document any visible separation. All observations were recorded.

Sub-samples were drawn at selected intervals during the trial. Samples were be pulled from designated sections (approximately ⅓ and ⅔ from the top and at the bottom) throughout each container and were be labeled accordingly and set aside for protein analysis.

For sampling, each sample was drawn using a new pipette, which was carefully and gently inserted into each sample to a known depth to draw the sample of a pre-determined amount from that layer.

Protein analysis will be conducted by N.P Analytical laboratories. Once protein data is returned variability between each layer of each sample will be calculated against the expected distribution of proteins when perfect suspension is assumed.

Samples of dry, unmixed feed were sampled from each bag of feed for particle size analysis. Partial size measurement was conducted by sifting through a series of increasingly fine mesh screens and weighing the amount that did not pass through the screen. The results are shown below in Table 1.

### Results:

Particle size analysis:

TABLE 1

| Bee Feed | | % greater than 45 |
|---|---|---|
| Supplement | % under 45 microns | microns |
| Bee Feed Product | %90 | %10 |
| (Hearty Bee) | | |
| Megabee | %63 | %37 |
| AP 23 | %60 | %40 |

Compared to Megabee and AP 23, the bee feed product (Hearty Bee) has a more uniform grind with 90% of the particles being under 45 μm, and only 10% of the particles having a size greater than 45 μm. This is in contrast to the Megabee product with 63% of the particles under 45 μm and 37% of the particles greater than 45 μm. Similarly, AP 23 had 60% of the particles under 45 μm and 40% of the particles greater than 45 μm. As a result of the more uniform size distribution, the particles of the bee feed product are more evenly distributed when mixed in the sugar-based syrup. Preliminary analysis of the protein levels in the suspension appears to show the protein from the bee feed product is distributed about 20 to 50% in each of the top, middle and bottom portions of the admixture. This is in contrast to Megabee, which appears to show protein from the product is about 80% in the top, about 4% in the middle, and about 16% in the bottom of the admixture. AP 23 appears to show the protein from the product is about 98% in the top of the admixture and about 1% in the middle and bottom of the admixture. Both Megabee and AP 23 shows an unacceptable amount of separation either to the top, bottom or both for these feeds. The bee feed product of the present disclosure in an admixture with sugar-based carbohydrate syrup appears to be more evenly distributed.

Trial 2. This example evaluated the suspension properties of AP 23, Megabee and the bee feed product disclosed herein (Hearty Bee) in solution.

### Materials and Methods:

Materials: The feeds tested included the same commercially available feed products evaluated in Trial 1, i.e., AP 23 (Dadant) and Megabee, along with the bee feed product disclosed herein (Hearty Bee).

Methods: The products were mixed using identical mixing equipment in equally dimensioned containers. A liquid solution of each product was prepared according to the instructions provided therewith. For example, to prepare solutions of the disclosed bee feed product and AP 23, a mixture of 5 wt % product powder and 95 wt % corn syrup was formed and mixed on a low speed setting for 30 minutes after all of the powder was in solution to ensure equal dispersion of the product in each solution. The mixer speed was kept low to avoid whipping any air into the solution, which may cause separation between the powdered product and the liquid. To prepare the Megabee solution, 1 pound of product powder was mixed with 2 gallons of corn syrup. All visible clumps of product powder were broken up and mixed into solution. An antifoaming agent comprised of Magrabar Silicone 10-sn was added to each solution to eliminate air bubbles.

The feeds were mixed on the same day and placed into a series of identical containers for the 1-week duration of the experiment. Each container was observed visually on a daily basis and photographed periodically throughout the trial to monitor any changes in the dispersion of the product powders in the respective liquid solutions. Physical protein samples were also collected from each solution at the beginning of the experiment and again after 24 hours to assess the dispersion of each product within the solution over time. Specifically, replicate protein samples were removed from the top ⅓, the middle ⅓, and the bottom ⅓ of each solution. Collecting protein samples in this manner revealed whether the particulate matter comprising each product settled to the bottom, floated to the top, or remained equally dispersed throughout each container. Each sample was extracted using a new pipette. The pipettes were inserted into each container at a consistent, known depth, and protein analysis performed by N.P. Analytical Laboratories. The results are shown below in Tables 2.1 (Megabee), 2.2 (AP 23) and 2.3 (bee feed product—Hearty Bee).

TABLE 2.1
Megabee

Protein Levels

| | 0 | 24 | | % |
|---|---|---|---|---|
| Portion sampled | hours | hours | difference | change |
| top ⅓ | 2.58 | 2.66 | 0.08 | 3.1 |
| | 2.07 | 2.02 | 0.05 | 2.42 |
| middle ⅓ | 2.13 | 3.01 | 0.88 | 41.31 |
| | 1.95 | 2.14 | 0.19 | 9.74 |
| bottom ⅓ | 2.35 | 2.55 | 0.20 | 8.51 |
| | 1.60 | 3.39 | 1.79 | 111.88 |
| Avg. difference | | | 0.532 | |
| Avg. % change | | | | 29.49 |

TABLE 2.2
AP 23

Protein Levels

| | 0 | 24 | | % |
|---|---|---|---|---|
| Portion sampled | hours | hours | difference | change |
| top ⅓ | 3.02 | 4.45 | 1.43 | 47.35 |
| | 1.98 | 3.47 | 1.49 | 75.25 |
| middle ⅓ | 3.20 | 3.29 | 0.09 | 2.81 |
| | 2.12 | 1.85 | 0.27 | 12.74 |
| bottom ⅓ | 3.68 | 1.34 | 2.34 | 63.59 |
| | 1.84 | 0.495 | 1.345 | 73.1 |
| Avg. difference | | | 1.1608 | |
| Avg. % change | | | | 45.81 |

TABLE 2.3
Hearty Bee

Protein Levels

| | 0 | 24 | | % |
|---|---|---|---|---|
| Portion sampled | hours | hours | difference | change |
| top ⅓ | 3.04 | 3.17 | 0.13 | 4.28 |
| | 2.56 | 2.46 | 0.10 | 3.91 |
| middle ⅓ | 2.69 | 2.46 | 0.23 | 8.55 |
| | 2.23 | 2.77 | 0.54 | 24.22 |
| bottom ⅓ | 3.19 | 2.87 | 0.32 | 10.03 |
| | 2.35 | 2.42 | 0.07 | 2.98 |
| Avg. difference | | | 0.2317 | |
| Avg. % change | | | | 8.96 |

As shown in Table 2.1, the Megabee product generally settled at the bottom of the container after 24 hours in solution, as the proportion of the product residing in the bottom ⅓ increased over time, and in one sample, increased by over 111%. Overall, the average percent change in dispersion of Megabee was over 29%. The AP 23 product generally floated to the top of the container after 24 hours in solution, evidenced by an increase in the proportion of the product residing in the top ⅓ of the container over time. The overall percent change in dispersion of AP 23 was nearly 46% after 24 hours. In contrast to the dispersion trends of Megabee and AP 23, the disclosed bee feed product (Hearty Bee) only showed an overall percent change of 8.96% after 24 hours, and none of the specific sub-portions of the product containers showed any appreciable increase or decrease in the proportion of product residing therein after 24 hours. Compared to the disclosed bee feed product, the average difference in protein distribution after just 24 hours was 2.3 times greater for Megabee and about 5 times greater for AP 23. The observed positional movement of the disclosed bee feed product was negligible to non-existent for an extended period of time after the first 24 hours in suspension, such that the dispersion observed at the 24-hour mark was substantially maintained for periods thereafter ranging from about 2, 3, 4, 5, 6, or 7 days. The disclosed bee feed products thus remained substantially more uniformly dispersed after 24 hours in solution than Megabee and AP 23, indicating that the disclosed feed products, when provided in a liquid solution, can provide a more consistent supply of protein over time than Megabee and AP 23.

In at least one example, a method of forming a liquid insect feed can involve admixing a dry insect feed with a sugar containing liquid, such as corn syrup. The insect feed can comprise dried blood meal and at least one additional feed component, and the dried blood meal present in the sugar-containing liquid can be included in an amount such that the admixed insect feed remains in suspension for at least 24 hours. In some examples, the liquid insect feed can comprise about 5 wt % dry insect feed and about 95 wt % sugar containing liquid. In some examples, the maintained suspension of the admixed insect feed can be evidenced by an approximately uniform distribution of the feed throughout a container holding the liquid insect feed over the 24 hour period. In specific examples, the uniform distribution can be exhibited by little to no change in the original, substantially equal distribution of the dry feed throughout the liquid. For example, the percent change in dry feed present in the top ⅓, middle ⅓ and bottom ⅓ of the liquid feed may be less than 10% over the 24 hour period.

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. An insect feed product, comprising:
particles of dried blood meal and at least one additional feed component.

2. The product of claim 1, wherein the dried blood meal is a primary protein source in the product, and wherein protein accounts for about 18 to about 70 wt % of the product.

3. The product of claim 1, wherein the dried blood meal is spray dried.

4. The product of claim 3, wherein the spray dried blood meal accounts for about 40 to 60 wt % of the product.

5. The product of claim 4, wherein the at least one additional feed component comprises yeast.

6. The product of claim 5, wherein the yeast accounts for about 40 to 60 wt % of the product.

7. The product of claim 1, wherein about 90% of the particles have a particle size of under about 45 μm, and about 98% of the particles have a particle size under about 55 μm.

8. The product of claim 1, wherein about 90% of the particles have a particle size under 45 μm, and about 10% of the particles have a particle size greater than 45 μm.

9. A method of forming a liquid insect feed, comprising:
admixing a dry insect feed with a sugar-containing liquid, the insect feed comprising dried blood meal and at least one additional feed component, the dried blood meal present in the sugar-containing liquid in an amount such that the admixed insect feed remains in suspension for at least one week.

10. The method of claim 9, wherein the sugar-containing liquid comprises corn syrup, sugar syrup, or liquid sucrose.

11. The method of claim 9, wherein the dried blood meal is spray dried.

12. The method of claim 11, wherein the spray dried blood meal accounts for about 40 to 60 wt % of the product.

13. The method of claim 9, wherein the at least one additional feed component comprises yeast.

14. The method of claim 13, wherein the yeast accounts for about 40 to 60 wt % of the product.

15. The method of claim 9, wherein about 90% of the particles have a particle size of under about 45 μm, and about 98% of the particles have a particle size under about 55 μm.

16. The method of claim 9, wherein about 90% of the particles have a particle size under 45 μm, and about 10% of the particles have a particle size greater than 45 μm.

17. A liquid insect feed product comprising particles of spray dried blood and at least one additional feed component suspended in liquid, wherein a viscosity of the liquid is about 400 to 600 cp and wherein the particles remain suspended in the liquid for at least two weeks.

18. The product of claim 17, wherein the liquid comprises corn syrup.
